(19) United States
(12) Patent Application Publication
(10) Pub. No.: US 2010/0024385 A1
(43) Pub. Date: Feb. 4, 2010

(54) PULSED PLASMA THRUSTER AND METHOD OF OPERATION THEREOF

(75) Inventors: Stephen Bernard Gabriel, Southampton (GB); Rodrigo Intini Marques, Southampton (GB)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: UNIVERSITY OF SOUTHAMPTON, Southampton (GB)

(21) Appl. No.: 12/441,875

(22) PCT Filed: Sep. 19, 2007
(86) PCT No.: PCT/GB2007/003543

§ 371 Date: Jun. 4, 2009

(30) Foreign Application Priority Data
Sep. 19, 2006 (GB) 0618410.5
Sep. 17, 2007 (GB) 0718076.3

(51) Int. Cl. F03H 1/00

(52) U.S. Cl. 60/203.1; 60/253

(57) ABSTRACT

A pulsed plasma thruster and method of operation are provided. The pulsed plasma thruster comprises solid propellant material. A main discharge source provides a pulsed discharge across the propellant material for ablating the propellant material to produce propellant plasma and accelerating the ablated propellant plasma, and an auxiliary discharge source accelerates late ablated propellant plasma without substantially further ablating the propellant material.

### FIELD OF THE INVENTION

The present invention relates to acceleration of sublimed material in a pulsed plasma thruster. In particular, the present invention relates to acceleration of late time ablated material from a thruster to provide thrust therefrom.

### BACKGROUND OF THE INVENTION

A pulsed plasma thruster (PPT) is an electric thruster used for attitude control, orbit maintenance (Guman e Nathanson, 1970; Vondra e Thomassen, 1974; Vondra, 1976), orbit transfer, drag compensation, and formation flying (Ebert et al, 1989) of satellites, space probes and other space vehicles.

These thrusters use a high-voltage discharge applied to the surface of a solid propellant (usually PTFE—Polytetrafluoroethylene). The propellant is sublimated, ionized and accelerated by a combination of electromagnetic forces (Lorenz Force) and thermal expansion to produce thrust.

The electric discharge takes place within a discharge chamber. There are several possible geometries of discharge chambers in PPTs. For example, a rectangular geometry may be provided. A spark plug is provided in this rectangular geometry in order to reduce the electric field E between the anode (positive +) and cathode (negative −), which is required to break the dielectric rigidity of the PTFE.

Pulsed plasma thrusters are electric thrusters that allow very precise manoeuvres and present relatively simple construction, reliability, low cost and a long lifetime. They can be used in satellites, space probes, and other spacecraft for orbit control and maintenance, orbit transfer, drag compensation and flight formation, and attitude control.

### SUMMARY OF THE INVENTION

Late ablation (also known as late time ablation (LTA)) is the sublimation of the propellant that takes place after a single pulse discharge is finished on the PPT and happens because the propellant surface remains hot after the discharge, above the sublimation temperature. This causes a significant part of the propellant (˜40%) to be ejected at very low speeds, compared to the speeds of electromagnetically accelerated propellant. This low speed material does not contribute significantly to the impulse generated by the PPT and therefore current PPTs use approximately only 60% of the propellant to produce usable thrust.

US2003/033,797 addresses the problem of late time ablation indirectly by using a relatively high, but constant frequency discharge However, the energy of the discharge is limited due to the use of the propellant as a capacitor as well as other energy limited storage components. Such a known design could be useful for small satellites, where impulse requirements are lower. This device is self-triggering, so the discharge frequency varies and is dependent on the current state of the propellant surface, which changes from one discharge to another *over the firing cycle*, and this can lead to variable impulse bit*thrust over the cycle*. Due to the very small discharge energy, ranging from 166 μJ to 5 mJ, the possibilities for surface charring (a major failure mode) increases. Such a known PPT is called QSMicro-PPT, because the size of the discharge chamber is very small compared to other PPTs. It is not recommended to have a rectangular design for a QSMicro-PPT, since the edge effects in the electrodes would become a serious issue.

The outstanding need for a triggered pulsed plasma thruster which can provide a wide range of thrust in the 1 μN to 10 N or more still exists.

An embodiment of the invention provides an improved pulsed plasma thruster. According to an aspect of the invention, late time ablated propellant in a pulsed plasma thruster is accelerated while avoiding further ablation of the propellant material. The ablation may be caused by a main discharge source. The late ablated material may conveniently be defined as material ablated from the propellant material after discharge from the main discharge source. The late ablated material may be ionised and accelerated by an auxiliary discharge source positioned sufficiently far from the solid propellant that further sublimation is reduced, avoided or substantially prevented. The auxiliary discharge source may be thermally insulated from the propellant material. The auxiliary discharge source may be sufficiently thermally insulated to reduce or substantially avoid late ablation of the propellant material during discharge by the auxiliary discharge source. The auxiliary discharge source may be positioned relative to the propellant to reduce, substantially avoid, or substantially prevent ablation of the propellant material. The auxiliary discharge source may comprise an auxiliary pair of electrodes. The auxiliary discharge source may be spatially separated from the main discharge source. At least a part of the auxiliary discharge source may be shared with the main discharge source. For example, a common cathode or anode may be provided between the main and auxiliary discharge sources, where pairs of electrodes are used. The auxiliary pair of electrodes may operate after a main discharge of the main discharge source. The main and/or auxiliary discharge sources may provide a pulsed, or rapid, current discharge. The auxiliary discharge source may comprise more than one pair of auxiliary electrodes. The main and auxiliary discharge sources may share one of their electrodes, the other electrode of each being separated. More than one main and/or auxiliary discharge source may be included. The current for discharge for one or more of the sources may be provided by one or more charged capacitors. An ignitor may be provided to reduce the voltage that needs to be applied across the main discharge source to ablate and ionise the propellant material for acceleration to provide thrust. The same, or a further, ignitor may also act in the region of the auxiliary discharge source. The main or auxiliary discharge source may include an ignitor, rather than the ignitor being separately provided. Alternatively, the ignitor may be omitted. Part or all of the ignitor may be shared with one or more of the main/auxiliary electrodes.

Aspects of the invention relate to a High Frequency Burst Pulsed Plasma Thruster (HFB-PPT) for use in spacecraft applications. This Pulsed Plasma Thruster (PPT) is a 4 electrode PPT capable of operating at high frequencies, typically up to 2 MHz or more. A benefit of this design is to accelerate the late ablation that occurs after the main discharge of propellant or to increase the main discharge exhaust speed. A typical burst is comprised of a main discharge followed by a subsequent discharge or multiple high frequency discharges downstream to either accelerate the late ablation of the main discharge or to further accelerate the propellant from the main discharge to increase the exhaust speed. This and other operation modes are possible due to the use of a embedded digital control circuit, however, the HFB-PPT may operate with a more basic control circuit if only a small number of subsequent discharges are intended. Alternatively, it may operate without a control circuit, when the first discharge triggers the second discharge in a ‘cascade’ mode, resembling a two-stage PPT. More than 2 pairs of electrodes may be employed to achieve a further increase in exhaust speed and/or to accelerate the late ablation.

Aspects of this invention relate to discharge chamber designs in Pulsed Plasma Thrusters as well as circuit designs for such a discharge chamber. Apparatus and methods of reducing late ablation are provided.

Thrusters according to aspects of the invention may be referred to as a High Frequency Burst Pulsed Plasma Thruster (HFB-PPT). This differs from conventional PPTs in the fact that it is capable of generating a subsequent pulse (or pulses) after the main discharge to accelerate slower material, resulting from late ablation, in a way that the maximum proportion, ideally 100%, of the propellant in a discharge is electromagnetically accelerated. It also differs from the QSMicroPPT, in that the frequency of operation of the HFP-PPT can be much higher, up to 2 MHz or more, depending on the propellant and geometric parameters. The design can have four electrodes, but, unlike the QSMicroPPT, only the first pair of electrodes has propellant between them. The second pair is used solely to accelerate the late ablating material away from the surface and thus increases the exhaust speed from the main discharge. A further characteristic of the design is that the cycle of discharges does not need to be regular, but can be in bursts.

The use of higher frequencies (up to 2 MHz or possibly more) is used for:
1) Making the initial conditions of every shot more uniform, resulting in less variability in thrust over time;
2) During a burst sequence (discharge cycle), one or more further impulses are imparted to the otherwise slow moving particles resulting from late ablation. To maximize efficiency, the second shot can be fired as quickly as possible (in time) to the first shot, at the highest suitable frequency;
3) Virtually eliminating the late ablation by a discrete discharge that takes place in another pair of electrodes, relatively far from the propellant surface;
4) Enabling different timings between the main discharge and the subsequent discharge;
5) Allowing the use of the second/third/fourth, etc, pair of electrodes as a main discharge booster only; and
6) Allowing the late ablation to be accelerated in bursts in the second/third/fourth, etc, pair of electrodes, after the main discharge, to match the much slower mass coming from the late sublimation.

The subsequent pulses, after the main pulse, are accomplished, in an embodiment of the invention, by employing an extra pair of electrodes downstream. They are located downstream to reduce the heating effects of the subsequent pulses on the surface of the propellant that would otherwise cause more sublimation of propellant. The second pair of electrodes may be used as a divergent nozzle. Other discharge chamber geometries are possible, including coaxial, side-feed and others.

In a particular design, in order to be able to control the discharge of the second pair of electrodes, a high current, high voltage switch is used. In one implementation of the HFB-PPT, these switches are controlled by a digital circuit. Control features for such a circuit, which accelerate material resulting from late ablation thus increasing exhaust speed, controlling the second pair of electrodes are:
a) Single delayed pulse self-triggering: that uses a switch to enable the discharge only after the main discharge.
b) Controlled single discharge: the discharge is controlled by a digital circuit and the discharge time and delay can be preset.
c) Controlled multiple discharges: the time before the first discharge and the time between each discharge as well as the discharge time of each pulse are controlled by a digital circuit.
d) Any combination of the above a, b and c.

Selection of the above features for a system implementation depends upon required performance and the acceptable complexity for each application.

### DETAILED DESCRIPTION OF EMBODIMENTS OF THE INVENTION

The present invention will now be described, purely by way of example, with reference to the accompanying drawings, in which:

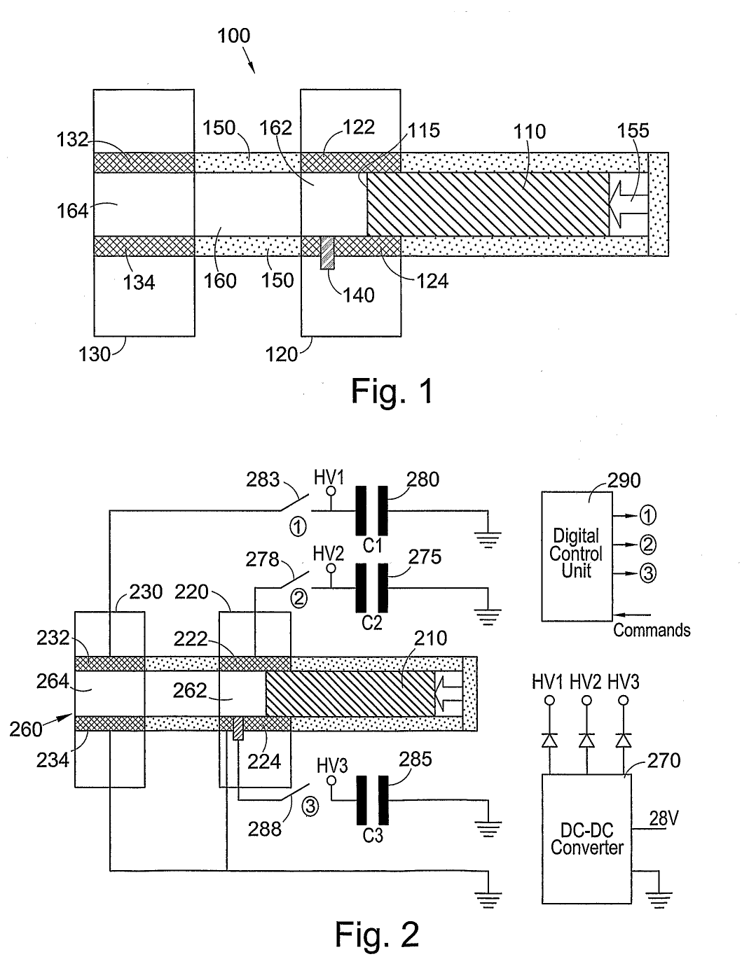

FIG. 1 shows a schematic cross section diagram of a pulsed plasma thruster according to an embodiment of the invention;

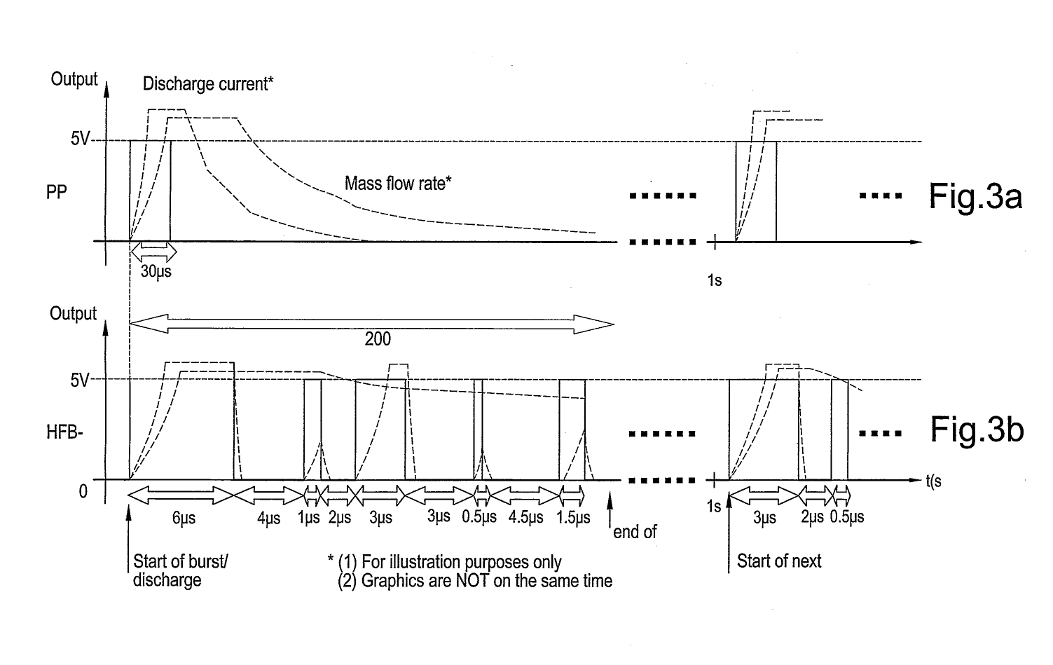

FIG. 2 shows a schematic cross section diagram of the pulsed plasma thruster of FIG. 1, with associated control circuitry;

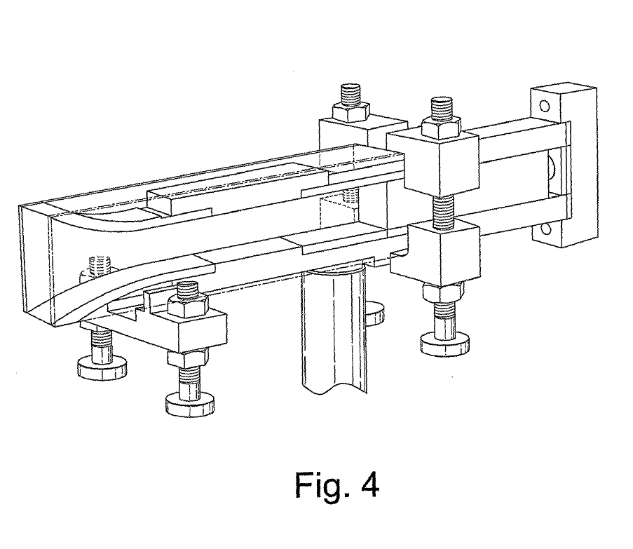

FIG. 3a shows an idealised graph of discharge control and the resultant mass flow rate against time for a conventional pulsed plasma thruster;

FIG. 3b shows an idealised graph of discharge control and the resultant mass flow rate against time for a discharge control according to an embodiment of the invention;

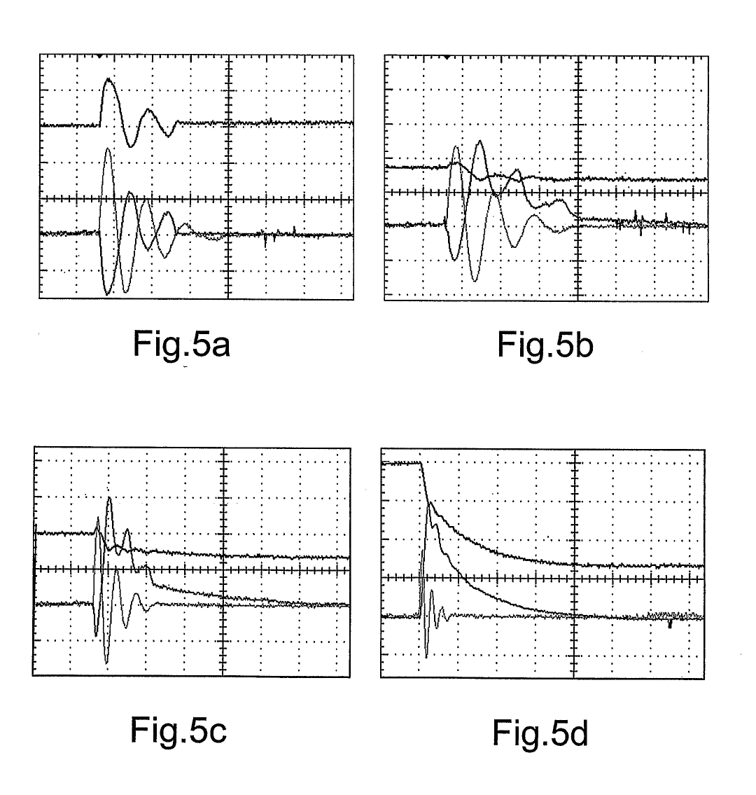

FIG. 4 shows a rectangular geometry thruster according to an embodiment of the invention;

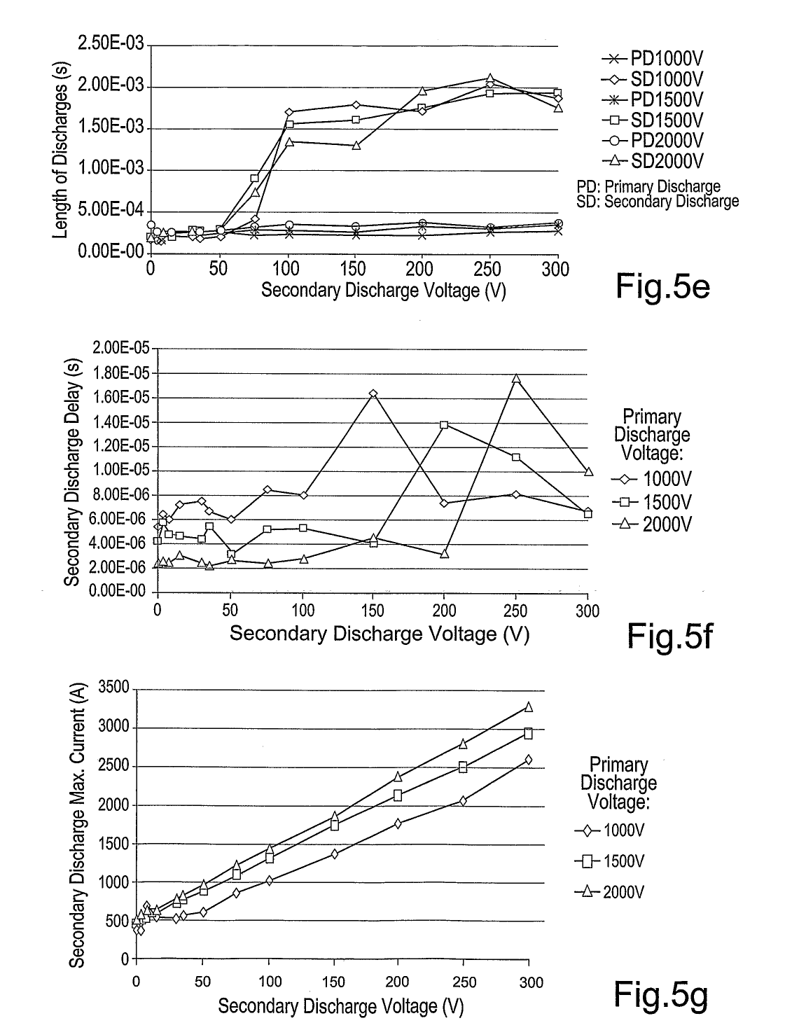

FIG. 5a shows a first regime of operation of the thruster of FIG. 4;

FIG. 5b shows a second regime of operation of the thruster of FIG. 4;

FIG. 5c shows a third regime of operation of the thruster of FIG. 4;

FIG. 5d shows a fourth regime of operation of the thruster of FIG. 4;

FIG. 5e shows a graph showing length of auxiliary discharge during operation of the thruster of FIG. 4;

FIG. 5f shows delay between the first discharge and second discharge during operation of the thruster of FIG. 4;

FIG. 5g shows a maximum current of auxiliary discharge as a function of the auxiliary discharge voltage during operation of the thruster of FIG. 4;

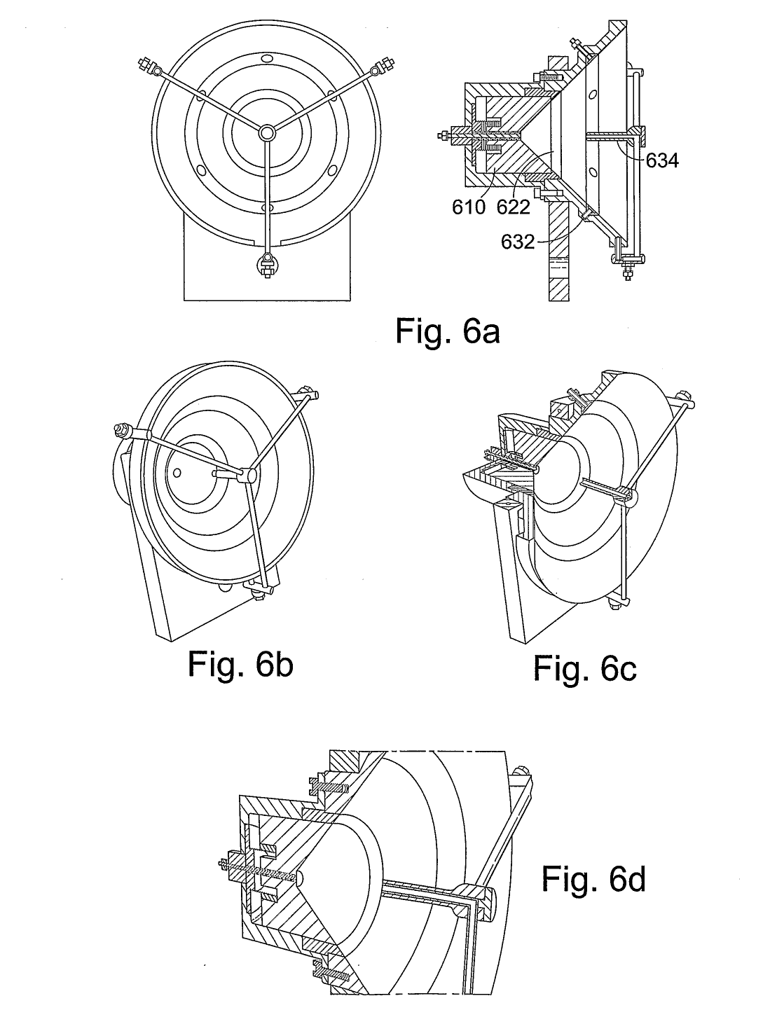

FIGS. 6a-d show an alternative embodiment of the invention; and

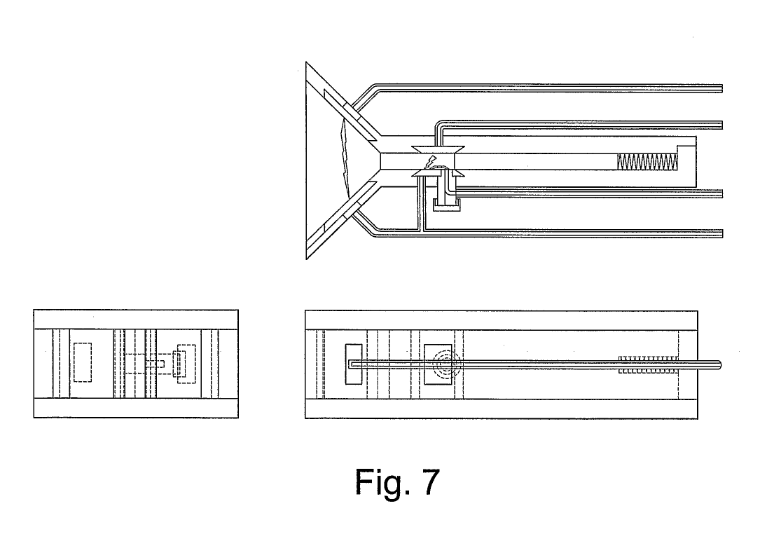

FIG. 7 shows a further alternative embodiment of the invention.

FIG. 1 shows a schematic cross section through a pulsed plasma thruster 100 according to a first embodiment of the invention. The thruster 100 comprises a propellant 110, a main discharge source 120, and an auxiliary discharge source 130.

In the present embodiment, the main discharge source 120 is in the form of a main pair of electrodes: anode 122, and cathode 124, placed on opposing sides of, and adjacent to, a face 115 of the propellant material 110, which in the present embodiment is PTFE. The main discharge source, in the present embodiment, also includes an ignitor 140, in the form of a spark plug, which is provided to reduce the electric field that needs to be applied to the electrodes 122, 124, to break the dielectric rigidity of the propellant material 110. In the present embodiment, the auxiliary discharge source is an auxiliary pair of electrodes: auxiliary anode 132 and auxiliary cathode 134.

Insulating material 150 is provided between the main and auxiliary discharge sources 120, 130, which may be sufficient to substantially prevent current leakage between the two sources. The auxiliary discharge source is separated from the propellant material to reduce, substantially avoid or substantially prevent ablation of the propellant material due to discharge from the auxiliary discharge source. In the present embodiment, the propellant is urged towards the main discharge source 120 by a spring 155, which acts between an insulating container for the propellant material and the propellant material itself. However, in embodiments of the invention, the spring may be omitted.

A chamber 160 has opposing sides defined by the main discharge source 120, insulator 150 and auxiliary discharge source 130. A closed end of the chamber 160 is defined by the face 115 of the propellant material 110, adjacent the main discharge source 120. The remaining sides are closed, while leaving an open end, which is defined opposite to the closed end, which is the outlet of the chamber 160. The auxiliary discharge source 130 is arranged nearer to the outlet than the main discharge source 120. The chamber 160 comprises two regions. The first region 162 is substantially between the electrodes 122, 124 of the main discharge source 120. A second region 164 is substantially between the electrodes 132, 134 of the auxiliary discharge source 130. Although the main and auxiliary discharge sources have been shown as opposing plate electrodes, alternative configurations are possible, for example concentric electrodes with annular propellant therebetween, or Z-pinch, side feed geometry, or others, as is known in the art.

In operation, the spring 155 urges the propellant material 110 towards the main electrodes 122, 124, so that the face 115 of the propellant material 110 is between the electrodes 122, 124. On firing, a high voltage main discharge (in the present embodiment of around 3000V) is applied between the main electrodes 122, 124. The two electrodes are, in the present embodiment, spaced by approximately 2.5 cm. An initial plasma seed is supplied by an ignition spark plug 140, allowing a discharge to occur between the electrodes 122, 124. The spark plug 140 can operate with voltages of up to 20 kV. Solid propellant material, from the face 115 of the propellant 110, is heated to cause ablation and the ablated material is ionised to form a plasma. The plasma is then accelerated away from the face 115 of the propellant 110 by the magnetic field caused by the current flowing between the main electrodes 122, 124 during discharge. The ablation occurs by joule effect heating. Once the main discharge has ended, the material in the face of the propellant 115 is still hot, and thus continues to sublimate, even after the electric field is removed. This late ablated material is thus not ionised nor accelerated by the main discharge source 120, but moves slowly along the chamber 160 from the first region 162 to the second region 164.

The auxiliary discharge source 130 is then discharged subsequently to the primary discharge, so that late ablated material is ionised and accelerated out of the outlet from the second region 164 of the chamber 160 in a much higher speed. The auxiliary discharge source 130 is separated from the face 115 of the propellant 110, and placed downstream in the plasma flow caused by the discharge, so that further sublimation of the propellant 110 is reduced during the auxiliary discharge. The separation of the auxiliary discharge source from the propellant material reduces the heating effect on the propellant 110. The auxiliary discharge is, in the present embodiment, also around 3000V. Thus, using both main and auxiliary discharges from separate discharge sources 120, 130, a high proportion of the total sublimated material is accelerated to provide thrust from the thruster, and late ablated material is not “wasted”; the efficiency is therefore improved. In an embodiment, the auxiliary discharge may occur at a time interval to boost the acceleration applied to the plasma produced and accelerated by the main discharge. This may occur instead of, or as well as ionising and accelerating the late ablated material.

The auxiliary discharge source 130 can be controlled to provide a single auxiliary discharge subsequent to the main discharge, or can be controlled to produce multiple discharges subsequent to a main discharge. FIG. 2 shows the thruster of FIG. 1, with control circuitry for controlling the discharges from the main and auxiliary discharge sources 220, 230. In the figures, like references refer to like elements, the initial numeral being changed to reflect the figure in which the element appears.

FIG. 2 shows a DC-DC converter 270. The converter 270 has a low voltage DC input (in the present embodiment 28V), which it converts to a high voltage output. The converter 270 provides a high voltage across three capacitors 275, 280, 285 (one side of each being grounded, the other being coupled to the converter 270). The first capacitor 275 is connected to an electrode 222 of the main discharge source 220 via a first switch 278. The first capacitor 275 has a capacitance of around 20 μFarad and a voltage applied of around 3000V. The second capacitor 280 is connected to an electrode 232 of the auxiliary discharge source 230 via a second switch 283. The second capacitor also has a capacitance of around 20 μFarad and an applied voltage of around 3000V. The other electrode in each of the main and auxiliary discharge sources is grounded. The third capacitor 285 is connected to the ignitor 240 via a third switch 288. The third capacitor has a capacitance of around 0.2 μFarad and an applied voltage of around 600V. The switches in the present embodiment are IGBT type transistors. A digital control unit 290 is provided to control the switches, and, hence, the discharges from the main and auxiliary discharge sources 220, 230 and the ignitor 240.

In operation, the converter 270 charges the capacitors 275, 280, 285. The digital controller 290 then controls the switches 278, 283, 288 as follows. The spark plug 240 is fired by closing the third switch 288 and discharging the third capacitor 285. The spark plug 140 can operate with voltages of up to 20 kV. This discharge from the ignitor 240 forms an initial plasma seed, which allows a main discharge to occur between the electrodes 222, 224. The first switch 278 is closed, which causes a high voltage to very rapidly appear across the main electrodes 222, 224, which provides the arcing and current across the electrodes required in the first region 262 of the chamber to sublimate the propellant, which is then ionised and accelerated towards the outlet of the chamber 260 by the magnetic field created in the first region 262 of the chamber between the main electrodes 222, 224, to create thrust. In an alternative embodiment, the first switch 278 may be removed; the discharge of current from the first capacitor 275 may occur once the arcing has been initiated by the ignitor 240. Alternatively, the charge across the first pair of electrodes 222, 224 when the first switch is opened may be sufficient to cause formation of propellant plasma without use of an ignitor.

Once the current flow across the main electrodes 222, 224 is stopped (either by full discharge of the first capacitor 275 or by opening of the switch 278), the face 215 of the propellant 210 is still hot, and, therefore, sublimation of the propellant 210 continues. Therefore, a suitable time after the firing of the main discharge source 220, the auxiliary discharge source 230 is fired to create an auxiliary discharge in the second region 264 of the chamber. This occurs by closing the second switch 283 to discharge the voltage in the second capacitor 280 to cause a current to flow across the auxiliary electrodes 232, 234. This auxiliary discharge ionises and accelerates the late ablated material, which has slowly travelled along the chamber 260 to the second region 264 of the chamber 160, providing further thrust from the late ablated material exiting the outlet in the chamber 260.

As well as a single auxiliary discharge, multiple auxiliary discharges may be produced form the auxiliary discharge source 230 after a single main discharge. For example, the second capacitor 280 may be recharged and discharged rapidly in succession such that multiple discharges are produced by the auxiliary discharge source 230, so as to ionise and accelerate the late ablated material in multiple auxiliary discharges. The switch 283 may be opened and closed rapidly, so that the capacitor 280 is not fully discharged in each cycle. Such multiple auxiliary discharges may be beneficial because the late ablated material may not be travelling at a uniform velocity along the chamber 260. Further, as the late ablated material is slow moving, the energy of the auxiliary pulses can be spread over a larger time period than if a single pulse was provided, so reducing the power requirements of the auxiliary discharge source.

As well as a switched trigger system, one or more of the switches may be omitted. In such an embodiment, the discharge source(s) without a switch are self-triggered once the voltage across the electrodes reaches a predetermined level to cause arcing. In such a system, the ignitor may be omitted.

FIGS. 3a and 3b show idealised graphs of discharge control and the resultant mass flow rate against time for a conventional pulsed plasma thruster and a thruster according to an embodiment of the present invention, respectively. In a conventional system, a single pulse is provided, which causes a single discharge current and an initial increase in mass flow rate. When the pulse ends, after approximately 30 μs in the idealised graph, in the present embodiment, the discharge current reduces, and the mass flow rate reduces in a similar fashion, as is expected where the magnetic field caused by the impulse causes the acceleration. The mass flow rate lags behind the discharge current. A relatively large proportion of the mass exits the thruster at a low velocity.

FIG. 3b shows an idealised discharge control graph according to an embodiment of the present invention. As in the conventional control, a discharge occurs, which causes a spike in the discharge current. In the embodiment, the initial pulse is shorter (6 μs) than described above. Further, the switch in the present embodiment is opened after a predetermined time, to cut off the voltage, and therefore the current, across the main electrodes. Once the main initial discharge has occurred, after a short time, of the order of the initial main discharge in the present embodiment, an auxiliary discharge occurs, as described above. As shown in FIG. 3b, this auxiliary discharge causes a high frequency pulsing of accelerating discharge. Further, as the auxiliary discharge causes no further ablation, the auxiliary discharges keep the mass flow rate high, and, when they finish, no or very little further late ablated material has formed, which has not been accelerated, so the cut of of thrust provided is relatively sharp. As described above, systems of the invention may also operate with only a single auxiliary discharge, rather than multiple auxiliary discharges.

FIG. 4 shows an embodiment of a thruster according to an embodiment of the invention, where the auxiliary electrodes are bent outwards, away from each other, to provide the thruster outlet. The thruster is otherwise configured as discussed above in relation to FIGS. 1 and 2.

FIGS. 5a to 5g show results provided on testing the thruster shown in FIG. 4. In a first phase of characterization of the PPT, a 110 μF capacitor is used for the main discharge and a 4700 μF capacitor for the auxiliary discharge. The high capacitance of the auxiliary discharge is chosen to investigate maximum lengths of auxiliary discharges. Three different main discharge voltages are shown: 1 kV, 1.5 kV and 2 kV; and fourteen different auxiliary discharge voltages: 0, 3.75, 7.5, 15, 30 35, 50, 75, 100, 150, 200, 250, and 300 V. A single second pulse is employed in all cases and there was no added delay between the first pulse and the second pulse. The intention with these tests was to observe how the currents and voltages of the auxiliary discharge behave with single pulse and zero delay in the DCU (Digital Control Unit) to serve as a base for the next tests. The low voltages applied to the auxiliary discharges are used to investigate the time of flight and the effects of the first discharge on the auxiliary discharge. In this mode the HFB-PPT operates in a similar fashion to a two-stage solid pulsed plasma thruster. Four distinct regimens were observed during the tests, delimited by increasing the second discharge voltage.
A. First Regimen (Shown in FIG. 5a) With very low voltages applied to the auxiliary electrodes, between 0 V and 50V (depending on the main discharge voltage), yields an oscillatory auxiliary discharge current approximately 90° out of phase with relation to the main discharge. The length of the discharge is approximately the same as the main discharge. Interestingly, a significant current was measured even when the auxiliary capacitor was initially completely discharged and at the end of the discharge there was a residual voltage in the capacitor, directly proportional to the main discharge voltage.
B. Second Regimen (Shown in FIG. 5b) At intermediate voltages, between 30 V and 75V (depending on the main discharge voltage), a mainly positive auxiliary discharge current is observed, with a reduction on the phase difference to the main discharge current. The length of the discharge is considerably longer than the first regimen, with a long tail after the main discharge is over.
C. Third Regimen (transition) (Shown in FIG. 5c) With the capacitor of the auxiliary discharge charged between 75 V and 100 V it is observed a transition regimen with two clear phases. The first phase is oscillatory and presents a higher peak, mainly positive current discharge. The second phase is a very distinct long tail that starts after the main discharge, resembling a critically damped circuit.
D. Fourth Regimen (Shown in FIG. 5d) The fourth and last regimen has a completely positive auxiliary discharge current and resembles the current shape of a critically damped circuit, although it also has a not so pronounced oscillating phase during the main discharge. The length of the auxiliary discharge is much longer than the main discharge.
E. Other measurements the length of the auxiliary discharge (FIG. 5e), delay with respect to the primary discharge (FIG. 5f) and maximum current (FIG. 5g) were also measured.

The first regimen is largely dependent on the main discharge and considerable current was observed even when the capacitor was initially discharged.

The second regimen has an offset, directly proportional to the auxiliary discharge voltage. The third regimen shows a relatively pronounced discharge tail after the main discharge and the fourth regimen shows a very long discharge tail after the main discharge. After the main discharge is over, there is no more plasma being produced upstream and the propellant starts to produce the LTA. It was hypothesised that the current flowing in the auxiliary electrodes, at this point, would supposedly be flowing in the LTA. Tests measuring the length of the discharge showed that by increasing the auxiliary discharge voltage the duration of the auxiliary discharge was also increased. However, for a given main discharge voltage, there is a maximum length of the auxiliary discharge. This characteristic supports the hypothesis that the auxiliary current discharge would be flowing on the LTA, as there is a limited amount of LTA for a given main discharge voltage. In fact, a residual voltage was measured in the auxiliary capacitor for auxiliary discharge voltages above 200 V. The maximum delay observed at different auxiliary discharge voltages indicates the transition of the auxiliary discharge from an oscillatory mode, with the first part negative, to a completely positive discharge. This transition occurs at different voltages, depending on the main discharge voltage. When there is 0 V applied on the auxiliary discharge capacitor, a current on the auxiliary electrodes is generated by the main discharge with the first bit negative. To overcome this first negative bit and initiate the positive only discharge mode it is necessary to have increasingly higher voltage applied on the auxiliary discharge capacitor as the main discharge voltage is increased. The voltages that correspond to the maximum delays can be seen as the voltages above which the discharge is completely positive. A finer change in the auxiliary discharge voltages is required to analyse exactly where the peak occurs and the behaviour in its vicinity.

FIGS. 6a, b, c and d show an alternative embodiment of the invention. While the long rectangular geometry discussed above provides a convenient way of observing the discharges, a significant amount of carbon deposition may occur on the inner surface of the lateral (non-electrode containing) walls. After a certain number of discharges, these carbon deposits may prevent the current from flowing on the (dielectric) propellant surface, due to its much higher conductivity. A coaxial geometry has been found to be suitable. In this embodiment, the electrodes are concentric and a spark plug is provided in the centre of the discharge chamber. To allow for the second set of electrodes, the coaxial design has a conical section, where the auxiliary electrodes would be mounted. To minimise the occurrence of carbon deposits, the conical section had an angle of 45 deg with the main rotational axis of the cone. Above this angle, the plume densities are very low and the deposits would also be minimised. A spark plug is provided, having two electrodes. The first is the anode of the spark plug, the second is the cathode of the spark plug. Between these two electrodes there is a PTFE hollow cylinder, which makes the spark plug essentially a coaxial PPT. The third electrode is the anode of the main discharge source. In this design the cathode of the main discharge source is not a separate electrode; instead the cathode of the spark plug is used. Between electrodes two and three is the solid propellant material, a conical shaped spring-fed PTFE. The fourth electrode is the auxiliary discharge source anode, placed in the conical section of the PPT. The auxiliary discharge source cathode is a rod placed in the axis of the thruster, suspended by three other rods and aligned with the auxiliary discharge source anode. In this embodiment, the spark plug discharge triggers the main discharge. The auxiliary discharge source cathode (central rod) and auxiliary discharge source anode are responsible for generating the additional discharges to accelerate the LTA.

FIG. 7 shows a diagram of an embodiment of the invention. It comprises a rectangular discharge chamber with a 20 mm×5 mm×45 mm PTFE propellant bar and a 45 deg angled nozzle where the auxiliary electrodes are assembled. The nozzle is arranged so that the plate auxiliary electrodes diverge in a direction away from the solid propellant material. The spark plug is mounted on the main cathode. In this design three separate capacitors are used for the spark plug, main discharge and auxiliary discharge, as discussed above. These capacitors are charged in parallel, and therefore have an equal charging voltage applied. The discharge initiation is triggered by voltage breakdown on the spark plug gap, again as discussed above.

The invention has been described with the aid of functional building blocks and method steps illustrating the performance of specified functions and relationships thereof. The boundaries of these functional building blocks and method steps have been arbitrarily defined herein for the convenience of the description. Alternate boundaries can be defined so long as the specified functions and relationships thereof are appropriately performed. Any such alternate boundaries are thus within the scope and spirit of the claimed invention.

The present invention has been described purely by way of example and various modifications and/or additions may be made and would be apparent to the person skilled in the art and fall within the scope and spirit of the invention.

Any discussion of the prior art throughout the specification is not an admission that such prior art is widely known or forms part of the common general knowledge in the field.

Unless the context clearly requires otherwise, the words “comprise”, “comprises”, “comprising” and the like are to be interpreted in an inclusive, rather than exclusive or exhaustive; that is to say, in the sense of “including but not limited to”.

1. A pulsed plasma thruster comprising: solid propellant material; a main discharge source for providing a pulsed discharge across the propellant material for ablating the propellant material to produce propellant plasma and accelerating the ablated propellant plasma; and an auxiliary discharge source for accelerating late ablated propellant without substantially ablating the propellant material.

2. A thruster according to claim 1, the auxiliary discharge source being spaced from the propellant material to avoid ablation of the propellant material, during discharge of the auxiliary discharge source.

3. A thruster according to claim 1, wherein the propellant material is thermally insulated from the auxiliary discharge source.

4. A thruster according to claim 1, wherein the auxiliary discharge source is for accelerating propellant produced after the end of a discharge from the main discharge source.

5. A thruster according to claim 1, wherein the main discharge source is a pair of electrodes.

6. A thruster according to claim 5, wherein the auxiliary discharge source is a further, auxiliary, pair of electrodes.

7. A thruster according to claim 6, the main pair of electrodes being positioned closer to the propellant material than the auxiliary pair of electrodes.

8. A thruster according to claim 7, the main pair of electrodes being positioned across a face of the propellant material.

9. A thruster according to claim 6, wherein a face of the propellant material is placed between the main pair of electrodes.

10. A thruster according to claim 6, wherein the main and auxiliary electrodes are opposing plate electrodes.

11. A thruster according to claim 1, wherein main and auxiliary discharge sources are arranged coaxially.

12. A thruster according to claim 11, wherein a first electrode of the main and auxiliary discharge sources are arranged on a central axis of the thruster, and another electrode of the main and auxiliary discharge sources are arranged conically around said axis.

13. A thruster according to claim 1, the auxiliary discharge source being positioned downstream in an, in use, plasma flow direction, produced by the main discharge source, from the main discharge source.

14. A thruster according to claim 1, wherein the main and auxiliary discharge sources are separated by insulating material.

15. A thruster according to claim 1, further comprising control circuitry to control the discharge from the main and auxiliary discharge sources.

16. A thruster according to claim 15, wherein the control circuitry is configured to control the main discharge source to provide a main voltage discharge, and to control the auxiliary discharge source to provide at least one subsequent auxiliary discharge.

17. A thruster according to claim 15, wherein the control circuitry is configured to provide a plurality of pulsed auxiliary discharges prior to a further main voltage discharge.

18. A thruster according to claim 1, further comprising a switch for activating the auxiliary discharge source subsequent to the activation of the main discharge source.

19. A thruster according to claim 6, further comprising a capacitor means coupled to each pair of electrodes for providing the discharge.

20. A thruster according to claim 1, further comprising an ignitor, for reducing the voltage discharge required from the main discharge source.

21. A satellite comprising a thruster according to claim 1.

22. A method of operating a pulsed plasma thruster, comprising: initiating a main discharge across a solid propellant material to ablate the material and accelerate the ablated material; initiating an auxiliary discharge across late ablated propellant to accelerate late ablated material without further substantially ablating the propellant material.

23. A method according to claim 22, wherein the late ablated material is accelerated by a pair of electrodes positioned sufficiently far from the solid propellant that further ablation is avoided.

24. A method according to claim 22, wherein the auxiliary discharge accelerates propellant produced after the end of a discharge from the main discharge source.

25. A method according to claim 22, further comprising applying a plurality of auxiliary discharges in the form of pulses prior to a further main discharge.

26. A method according to claim 22, wherein the auxiliary discharge occurs subsequent to the main discharge.

27. A method according to claim 22, further comprising applying an ignition to reduce the voltage of the main discharge.

28. (canceled)

29. (canceled)
